(19) United States
(12) Patent Application Publication
(10) Pub. No.: US 2023/0029062 A1
(43) Pub. Date: Jan. 26, 2023

(54) Roof Shingle Installer Tool Nail U Punch with Magnet Nail Holder

(71) Applicant: Ville Javanainen, Mendon, MA (US)

(72) Inventor: Ville Javanainen, Mendon, MA (US)

(21) Appl. No.: 17/384,322

(22) Filed: Jul. 23, 2021

(51) Int. Cl. B25C 3/00; E04D 15/02; E04D 1/34

(52) U.S. Cl. CPC B25C 3/008; E04D 15/02; E04D 1/34; E04D 2001/3423

(57) ABSTRACT

The invention is a steel hand-held u-shaped roofing tool that allows for and facilitates the installation of new roofing shingles underneath existing asphalt shingles. The invention utilizes a unique steel shape and accompanying embedded magnet to accomplish this. The main parts are the body that distributes hammer impacts from above around a void that the old shingle slides into. A protected embedded magnet that holds the roofing nails perpendicular to the bottom surface of the tool.

### FIELD OF INVENTION

The invention relates to novel tools for installing replacement asphalt roof shingles on existing roofs. More particularly the invention relates to a nail placement and positioning device for nailing under existing shingles.

### BACKGROUND OF INVENTION

Roof shingles often require replacement due to damage from many sources such as wind or hail or just improper installation. The traditional method of installing new shingles and weaving them into the old shingles is cumbersome, time consuming, and often leads to additional damage to surrounding shingles. This discourages roofers and homeowners alike from performing localized repairs and instead opting to replace the entire roof. The invention is used by all demographics but mostly by do it yourselfers and professional roofers.

### BRIEF SUMMARY OF INVENTION

The invention allows a person performing asphalt roof shingle repairs to replace broken shingles without disturbing surrounding shingles or causing additional damage to surrounding shingles and, by holding the nail with a magnet, frees up one hand to swing a hammer.

### BRIEF DESCRIPTION OF DRAWINGS

FIG. 1 is a bottom perspective view illustrating one preferred embodiment of a tool according to the present invention.

FIG. 2 is a left view of the tool showing its placement and usage by the operator with a hammer.

### DETAILED DESCRIPTION OF THE INVENTION

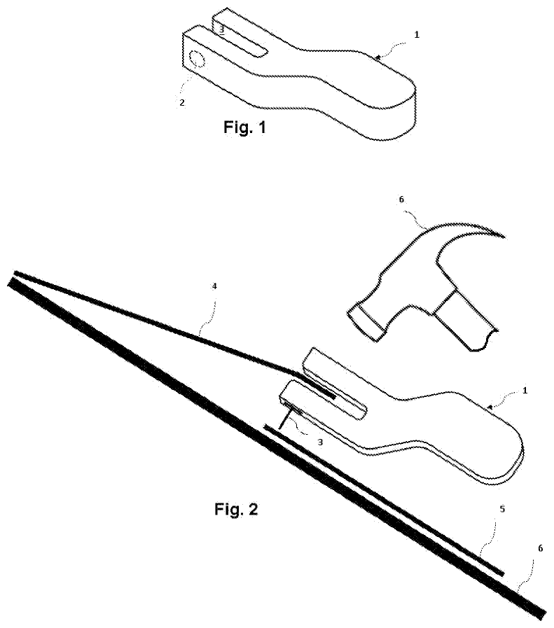

Tool is made of hardened structural steel and is shaped like a tuning fork. The shape forms a recess that old shingle 4 can slide into thus allowing nailing forces from the top to be driven around void 3 (FIG. 2). On the bottom of the tool (FIG. 1) is a hole where cylinder magnet 2 is inserted and permanently attached flush with the surface with adhesive. Using the tool solves a common problem roofers face while installing new shingles. The main problem is new shingle 5 must slide under the top old shingle 4 and be nailed down under shingle 4. To make room to swing using the conventional method a hammer at the nail the top shingle must then be held back and flexed to 90° C. degrees, which often end up cracking or breaking it, leading to additional damage and repairs.

The second problem the roofer has is that he needs one hand to hold the nail in place for setting, one hand for striking the hammer, and at the same time needs to hold back the top shingle This steel tool invention solves these problems by distributing the force of hammer 6 blows around old shingle 4 thus minimizing having to flex the old shingle, while at the same time holding nail 3 in setting position with magnet 2. The invention is thus an improvement over the old technology, using a hammer and a nail, which result in cracking and tearing of existing shingles.

The benefits of the tool are that it increases the quality of shingle installations, increases the speed of shingle installation, increases the safety of roof shingle installation and generally reduces roof time

1. A hand-held tool comprising:
(a) a elongated u steel shape body 1 means that will distribute hammer 6 impacts around void 3, directing the impact to the surface opposite of side impacted to nail 3.
(b) a embedded magnet 2 encasing said elongated u steel shape body, one portion being exposed from end thereof to expose end of said magnet to ferrous nail 3 whereby said body protects said magnet means from impact breakage and provides a magnetic means for holding said nail means conveniently.
